(19) United States
(12) Patent Application Publication
(10) Pub. No.: US 2017/0248023 A1
(43) Pub. Date: Aug. 31, 2017

(54) METHOD FOR MANUFACTURING A TURBINE ASSEMBLY

(71) Applicant: Siemens Aktiengesellschaft, Munich (DE)

(72) Inventor: Richard Bluck, Welton, Lincoln (GB)

(73) Assignee: Siemens Aktiengesellschaft, Munich (DE)

(21) Appl. No.: 15/504,351

(22) PCT Filed: Aug. 18, 2015
(86) PCT No.: PCT/EP2015/068971

§ 371 Date: Feb. 16, 2017

(30) Foreign Application Priority Data
Aug. 28, 2014 (EP) 14182727.9

(51) Int. Cl. F01D 5/18; F01D 25/12; F01D 5/14; F01D 9/02

(52) U.S. Cl. CPC F01D 5/187; F01D 9/02; F01D 25/12; F01D 5/147; F05D 2230/60

(57) ABSTRACT

A method for manufacturing a turbine assembly having at least one aerofoil unit including at least a basically hollow aerofoil with at least one cooling passage for a cooling medium and at least one entry surface, wherein the at least one cooling passage enters at the at least one entry surface, and further the turbine assembly has at least one cover plate that at least partially covers the at least one entry surface. In order to provide a reliable attachment the method includes the step of attaching the at least one cover plate with one single, continuous, connecting structure to the at least one aerofoil unit.

### CROSS REFERENCE TO RELATED APPLICATIONS

This application is the US National Stage of International Application No. PCT/EP2015/068971 filed Aug. 18, 2015, and claims the benefit thereof. The International Application claims the benefit of European Application No. EP14182727 filed Aug. 28, 2014. All of the applications are incorporated by reference herein in their entirety.

### FIELD OF THE INVENTION

The present invention relates to a method for manufacturing a turbine assembly. The present invention further relates to an aerofoil-shaped turbine assembly such as turbine rotor blades and stator vanes, and to a use of a cover plate as a sealing plate.

### BACKGROUND TO THE INVENTION

Modern turbines often operate at extremely high temperatures. The effect of temperature on the turbine blades, stator vanes and surrounding components can be detrimental to the efficient operation of the turbine and can, in extreme circumstances, lead to distortion and possible failure of such components. In order to overcome this risk, high temperature turbines may include hollow blades or vanes comprising cooling passages for a cooling medium to cool the blades and vanes during operation of the turbine assembly.

Such blades or vanes with e.g. an inner serpentine geometry for the cooling passages are typically made by an investment casting process which uses a ceramic core to define the various internal passages. After casting, the ceramic core is removed from the blade by a leaching process.

The cooling passages may extend through to the bottom of the blade root. In order to control the flow of cooling air through the blade or to seal unused openings of the cooling passages remaining from the casting process a separate cover plate may be provided. It is imperative that this plate remains attached to the blade, therefore welding of the cover plate is used. E.g. discrete spot welds are used to weld the cover plate to the blade. In this instance the welds are located at positions where there is sufficient available space between the openings of the internal cooling passages and the perimeter of the cover plate. Such an attachment results in several disadvantages. For example the relative thermal expansion between the cover plate and the blade may differ, particularly during transient operation where the thinner cover plate will respond more quickly than the blade. This will set-up weakening stresses in the welds. As the welds are non-continuous they may have insufficient strength, leading the failure of the weld/s and to a detachment of the cover plate. Furthermore, the contraction of the cover plate around the heat affected zone of each weld is known to cause the cover plate to lift-off from the surface of the blade in-between each weld. This creates a gap which can allow an unintentional flow of significant levels of cooling air into the cooling passages within the blade—which may be detrimental to engine performance.

Moreover, in certain instances the relative size of the cast-in internal cooling passages and the width of the machined root on the outside of the blade combine to leave insufficient area to enable a conventional thru-weld along the perimeter of the cover plate—when the effect of tolerances are taken into account.

### SUMMARY OF INVENTION

It is a first objective of the present invention to provide a method for manufacturing a turbine assembly with which the above-mentioned shortcomings can be mitigated, and especially a secure attachment of the cover plate to the aerofoil and/or a reliable sealing of the cooling passages is facilitated.

It is a second objective of the invention to provide an advantageous aerofoil-shaped turbine assembly such as a turbine rotor blade and a stator vane. A third objective of the invention is to provide a use of a cover plate in such a turbine assembly for sealing purposes.

These objectives may be solved by a method, a turbine assembly and a use of a cover plate according to the subject-matter of the independent claims.

Accordingly, the present invention provides a method for manufacturing a turbine assembly comprising at least one aerofoil unit comprising at least a basically hollow aerofoil with at least one cooling passage for a cooling medium and at least one entry surface, wherein the at least one cooling passage enters at the at least one entry surface, and further the turbine assembly comprises at least one cover plate that at least partially covers the at least one entry surface.

It is provided that the method comprises the step of: Attaching the at least one cover plate with one single, continuous, connecting structure to the at least one aerofoil unit.

Due to the inventive method a secure attachment of the cover plate to the aerofoil unit and a reliable sealing of the cooling passage(s) is provided. Furthermore, stresses caused by the differential thermal growth of the cover plate vs the aerofoil unit, e.g. along a span of the cover plate, can be minimised. Moreover, any lift-off of the cover plate from the aerofoil is overcome by centrifugal forces during operation of the turbine assembly which cause the plate to mostly seal against the entry surface, thus reducing and leakage of cooling flow.

Even if a term like aerofoil, passage, medium, surface, cover plate, end, orifice, aperture, border, set, platform or root portion is used in the singular or in a specific numeral form in the claims and the specification the scope of the patent (application) should not be restricted to the singular or the specific numeral form. It should also lie in the scope of the invention to have more than one or a plurality of the above mentioned structure(s).

A turbine assembly is intended to mean an assembly provided for a turbine engine, like a gas turbine, wherein the assembly possesses at least one an aerofoil unit. The turbine assembly may be a part of a turbine wheel or a turbine cascade with circumferential arranged aerofoil units. An aerofoil unit is intended to mean a unit comprising at least an aerofoil and further structures, like a root portion and/or an outer and/or an inner platform. The latter two would be arranged at opposed ends of the aerofoil(s) and/or the inner platform would be arranged between the aerofoil and the root portion.

In this context a “basically hollow aerofoil” means an aerofoil with a casing, wherein the casing encases at least one cavity and/or cooling passage. A structure, like a rip, which divides different cavities/passages in the aerofoil from one another and for example extends in a span wise direction of the aerofoil, does not hinder the definition of “a basically hollow aerofoil”. In particular, the basically hollow aerofoil, referred as aerofoil in the following description, has two cooling regions, a channelled cooling region at a leading edge of the aerofoil and a state of the art pin-fin/pedestal cooling region at the trailing edge. These regions could be separated from one another through a rip.

In this context an entry surface of the aerofoil unit is a surface where a cooling passage starts or ends depending on a flow direction of the cooling medium. The surface advantageously has at least one aperture providing an exit or entry for the cooling medium from/in the cooling passage(s). The entry surface may be located in any region of the aerofoil unit e.g. at the root portion or at one of the platforms or at the aerofoil. Advantageously , it is located at the root portion and specifically at its radial end (end located in the mounted state of the aerofoil unit in the turbine assembly or turbine engine radially nearest to an axis of the turbine assembly or turbine engine). The cooling passage may have any shape or distribution feasible for a person skilled in the art, like extending one-directional in span wise direction of the aerofoil unit or having a meandering pattern or a serpentine like pattern with changing/opposed directions. A span wise direction of the aerofoil unit is defined as a direction extending basically perpendicular, advantageously perpendicular, to a direction from a leading edge to a trailing edge of the aerofoil.

Advantageously, the cooling medium enters the aerofoil or the cooling passage at the entry surface. In case of an embodiment of the cooling passage as an open cooing circuit no cooling medium would leave the cooling passage at the entry surface. In case of two or more entry apertures located at the entry surface respective streams of cooling medium may be kept entirely separate inside the aerofoil or join to one stream at some point in the internal cooling circuit. If, on the other hand, the cooling circuit is embodied as closed loop type the cooling medium would probably not leave via the aerofoil but more likely near where it entered i.e. in the root portion or the aperture(s) in the entry surface. In that case the entry surface or parts thereof could be named exit surface.

A cover plate is intended to mean a basically planar structure that is embodied in such a way to cover and/or seal at least a section of the entry surface after the assembly of the turbine assembly at least in the operational state of the turbine assembly. Here, “basically planar” should be understood as that a small unevenness of a plate surface and/or of a planar shape of the cover plate should not hinder the definition of the cover plate as being planar. Further, the cover plate may have specifically selected structure(s) or shape(s), like a hole, curvature, bend or the like, that may influence a flow characteristic of the cooling medium and/or an aerodynamic property of the turbine assembly.

In this context the term “attaching” should be understood as using any attachment method feasible for a person skilled in the art that especially provides a secure attachment of the cover plate to the aerofoil unit even during rotation of the turbine assembly. That may be any joining method working with an adhesive bond, e.g. gluing, and especially any thermal bonding technique, like welding, brazing etc. According to another refinement, the method comprises the step of: Attaching the at least one cover plate by welding. Due to this an especially strong attachment can be facilitated that is further manufactured easily. Thus, the connecting structure is advantageously a single, continuous, one-directional weld.

A splitting (two legged) rivet with a corresponding third part contacting the entry surface would be an alternatively embodied connecting structure, particularly for larger aerofoils or blades. Moreover it could be possible to pre-attach the cover plate to the aerofoil unit beforehand of the final attachment step to fixate the cover plate before it is e.g. welded. This could be e.g. done by gluing. Further, it would be possible to attach a centre part of the cover plate to the root of the aerofoil by a combination of a deformable feature of the cover plate and the counter feature of the aerofoil or its root portion.

The term “continuous” should be understood as without a break or gap. Continuity of the continuous connecting structure can also be achieved by several sub-connecting structures being stringed together continuously without breaks of gaps in-between. The connecting structure is advantageously basically one-directional, wherein basically one-directional should be understood as that slight unevenness's or bends up to a divergence of 10° from the straight configuration should be understood as one-directional. Especially structures with bends or direction changes with an angle of more than 25° are not considered as one-directional.

Moreover, it is provided that the at least one cover plate comprises at least one end, a centroid and an edge point, wherein a metric function of the centroid and the edge point has a maximum and wherein the maximum is located at the at least one end of the at least one cover plate and wherein the method comprises the step of: Attaching the at least one cover plate in such a way so that the at least one end is a free end in respect to the at least one aerofoil unit or in other words, is unattached to the at least one aerofoil unit. Thus, the end of the cover plate is free to react to external forces, like centrifugal forces acing on the cover plate during operation of the turbine assembly. This reduces stresses in the cover plate and hinders the lift-off of the cover plate from the entry surface the aerofoil unit or its root portion. The attachment of the end to the entry surface is no adhesive bond between the end of the cover plate and the aerofoil unit or its root portion. A metric function should be understood as a distance function, further an end as an edge, rim, border, corner etc. of the cover plate. Advantageously, the cover plate comprises two opposed arranged ends with the connecting structure arranged basically in the middle between the two opposed ends. Thus, this construction provides free ends of the cover plate after attachment.

Advantageously, the method comprises the step of: Attaching the at least one sealing plate in such a way to allow the at least one end and advantageously the two opposed ends to be pressed—air—tight to the at least one aerofoil unit or its root portion during an operational state of the turbine assembly. Hence, the cover plate can perform its function efficient and reliably. This is especially operationally easily done, when the characteristics and dimensions of the cover plate or its structures are selected to establish this tight fit due to centrifugal forces acting on the cover plate during operation.

This may be a special predefined shape or bending, which the cover plate has beforehand of the final attachment step or a special pre-attachment of the cover plate. For example a machining operation e. g. milling in the orifice(s) or (a) special recess(es) could improve the dimensional tolerances and make the cover plate fit more snugly. In other words the manufacturing process is not relying on the precision casting on its own for the shape of the recess. Even if it is normal practice to apply a pressure during the attachment process to the free end/s of the cover plate in order to minimise the effect of heat causing the free ends to stand-off it would be also possible to apply a selected or gradual pressure to the cover plate during the attachment step to influence the degree of the fit of the cover plate or its free ends to the entry surface.

Furthermore, it is advantageous when the method comprises the step of: Attaching the at least one cover plate in such a way that the connecting structure extends through the centroid. Hence, the attachment of the cover plates can be achieved in a balancing fashion in respect to its dimensions. In this context the wording “extending through” should be understood as coinciding with or that one point of the connecting structure superpose the centroid. Moreover, the connecting structure represents or is advantageously a symmetry axis of the cover plate.

In addition, it is advantageous when the at least one cover plate comprises at least two orifices that are in communication with the cooling passage. Thus, the cover plate may be used to influence a flow of the cooling medium either entering or exiting the aerofoil unit or its cooling passage(s). The cover plate may be also named as orifice plate. The phrase “in communication with” should be understood as a direct alignment of the orifice with the cooling passage or its aperture, respectively. The orifice may be an exit or an access opening for the cooling medium depending on the flow direction of the cooling medium. Moreover, the orifice may have any shape feasible for a person skilled in the art, like, round, oval, egg-shaped, rectangular etc. Furthermore, the shape may be matched to the shape or size of the respective and corresponding aperture of the cooling passage. Further, the cover plate may comprise more than two orifices.

In a further advantageous embodiment the method comprises the step of: Attaching the at least one cover plate to the at least one aerofoil unit basically in a middle between the at least two orifices of the at least one cover plate. Hence, by forming the connecting structure in this region of the cover plate the structural integrity of the orifices is unaffected by the forming process. A middle should be understood as a mid-point of the distance between the mid-points of the orifices. The phrasing “located basically in a middle” is intended to mean that a location of the connecting structure with a deviation of ±10% from the mid-point from the strictly middle position should be understood as located in a middle. In other words the connecting structure may be located within ±10% of the length of the cover plate from the mid-point along that length.

It is a further object of the present invention to provide a turbine assembly manufactured according to the inventive method. Thus, the turbine assembly comprises the at least one aerofoil unit comprising the at least one basically hollow aerofoil with at least one cooling passage for the cooling medium and at least one entry surface, wherein the at least one cooling passage enters at the at least one entry surface, and further comprising the at least one cover plate that at least partially covers the at least one entry surface.

Due to this a turbine assembly with a securely attached cover plate to the aerofoil unit can be provided enabling a reliable sealing of the cooling passage(s). Furthermore, stresses caused by the differential thermal growth of the cover plate vs the aerofoil unit, e.g. along a span of the cover plate, can be minimised. Moreover, any lift-off of the cover plate from the aerofoil is overcome by centrifugal forces during operation of the turbine assembly which cause the plate to mostly seal against the entry surface, thus reducing and leakage of cooling flow. As a result, the turbine assembly can be operated reliably and failure-proof.

As stated above the at least one aerofoil unit or advantageously its root portion comprises at least two apertures communicating with the at least one cooling passage. Favourably, the connecting structure extends through a mid-point being located basically in a middle between the at least two apertures. Hence, the connecting structure is positioned in a region of the aerofoil unit or its root portion, respectively, where a wall thickness needed for the attachment is sufficient for a proper attachment of the cover plate. For a definition of the phrasing “located basically in a middle” it is referred to the definition provided above. Further, the aerofoil or its root portion may comprise more than two apertures.

According to a further realisation of the invention the at least one cover plate comprises at least one border, a centroid and an edge point, wherein a metric function of the centroid and the edge point has a maximum and wherein a maximum of the metric function is located on the at least one border of the at least one cover plate and wherein the at least one border is free or is unattached to the at least one aerofoil unit. Hence, the border of the cover plate is free to react to external forces, like centrifugal forces acing on the cover plate during operation of the turbine assembly. This reduces stresses in the cover plate and overcomes the lift-off of the cover plate from the entry surface of the aerofoil unit or its root portion that may be caused by e.g. welding of the cover plate.

Advantageously, the at least one cover plate comprises two opposed borders, wherein a stable and tight attachment can be provided, when the connecting structure extends between the two opposed borders. In this context “extend between” should be understood as extending in a direction pointing from one border to the other border and/or that one end of the connecting structure in nearer to a first boarder and the opposed end of the connecting structure is nearer to the second opposed border. The extension of the connecting structure between the two borders can have any length suitable for a person skilled in the art for a proper attachment e.g. 25%, 50% or 100% of the distance between the borders. In another embodiment of the invention the connecting structure extends all between the two opposed borders. In other words, the connecting structure starts at a first border and ends at a second border arranged opposed to the first border. This ensures a stable connection of the cover plate to the aerofoil unit. The two borders may have the same length or their lengths may differ from one another. Advantageously, they have the same length.

Beneficially, the at least one cover plate comprises a first set of two opposed borders and a second set of two opposed borders. All four borders may have the same length. Advantageously, the first set of two opposed borders are shorter than the second set of two opposed borders, providing a predefined mounting orientation of the cover plate, especially in respect to a shape of the aerofoil unit or the entry surface. Thus, the cover plate has two long borders and two short borders.

According to a further embodiment of the invention the connecting structure extends basically perpendicular to the opposed borders of the second set of two opposed borders. This establishes a balanced attachment of the cover plate. Moreover, since the connecting structure extends between the second set of borders and thus the two long borders the free ends—the shorter borders of the first set—may have a higher flexibility to allow the tight fit due to the centrifugal force in comparison with an attachment providing free ends at the shorter borders. In the scope of an arrangement of the connecting structure as “basically perpendicular” to the opposed borders should also lie a divergence of the connecting structure in respect to the borders of about 30°. Advantageously, the connecting structure is arranged perpendicular to the borders.

Generally, the cover plate may have any shape feasible for a person skilled in the art, like rectangular, triangular, round, oval etc. Advantageously, the at least one cover plate has a basically tetragonal shape providing an easy to manufacture cover plate. Advantageously, the at least one cover plate has a basically rectangular shape. Thus, the shape of the cover plate is matched to a shape of the aerofoil unit or its root portion. In this context “basically rectangular” should be understood as with corners having angles between 80°-100°.

As stated above the at least one aerofoil unit comprises at least two apertures communicating with the at least one cooling passage and the at least one cover plate comprises at least one orifice. In a further realisation of the invention it is provided that the at least one orifice of the at least one cover plate communicates with at least one aperture of the at least two apertures of the aerofoil unit. Thus, the orifice can be used to direct or channel the cooling medium entering or exiting the cooling passage through the aperture.

Further, the cover plate may comprise a number of orifices equal to the number of apertures of the cooling passage in the entry surface. Thus, the cover plate may have one orifice at either side of the connecting structure or even more than one orifice e.g. arranged one above the other basically in parallel to the connecting structure (A line connecting the mid-points of the orifices is basically in parallel to the connecting structure.), wherein a “basically parallel arrangement” is intended to mean a divergence of the arrangement of the orifices in respect to the connecting structure of about 30° from their strictly parallel arrangement.

Furthermore, the at least one orifice of the at least one cover plate has a smaller diameter than a diameter of at least one aperture of the at least two apertures of the aerofoil unit. This enables an especially easy way to influence the flow of cooling medium.

In a further advantageous embodiment the aerofoil unit is a turbine blade or vane, and especially a turbine blade.

The invention further provides a use of a cover plate as a sealing plate, wherein the cover plate seals at least one cooling passage of an aerofoil unit of an inventive turbine to prevent a flow of cooling medium into and/or from the at least one cooling passage during operation of the turbine assembly, especially due to a centrifugal force acting on the at least one sealing plate during operation of the turbine assembly.

Due to this a sealed attachment of the cover plate to the aerofoil unit with a reliable sealing of the cooling passage(s) is provided. Further, any lift-off of the cover plate from the aerofoil unit as a result of e.g. welding is overcome by the centrifugal forces which cause the cover plate to mostly seal against the entry surface, thus reducing and leakage of cooling flow.

The above-described characteristics, features and advantages of this invention and the manner in which they are achieved are clear and clearly understood in connection with the following description of exemplary embodiments which are explained in connection with the drawings.

### BRIEF DESCRIPTION OF THE DRAWINGS

The present invention will be described with reference to drawings in which:

FIG. 1: shows a schematically and sectional view of a gas turbine engine comprising several inventive turbine assemblies,

FIG. 2: shows a perspective view of one turbine assembly of FIG. 1 with an aerofoil unit with a cut-away section showing cooling passages and a cover plate,

FIG. 3: shows a cross section through a root portion of the turbine assembly along line III-III in FIG. 2,

FIG. 4: shows a bottom view of the turbine assembly showing the connecting structure attaching the cover plate to the root portion,

FIG. 5: shows a bottom view of the turbine assembly with an entry surface for the cooling passage shown in FIG. 2 and

FIG. 6: shows the cover plate from FIG. 2 unattached to the aerofoil unit.

### DETAILED DESCRIPTION OF THE ILLUSTRATED EMBODIMENTS

The terms upstream and downstream refer to the flow direction of the airflow and/or working gas flow through the engine 44 unless otherwise stated. If used and not otherwise stated, the terms axial, radial and circumferential are made with reference to a rotational axis 54 of the engine 44.

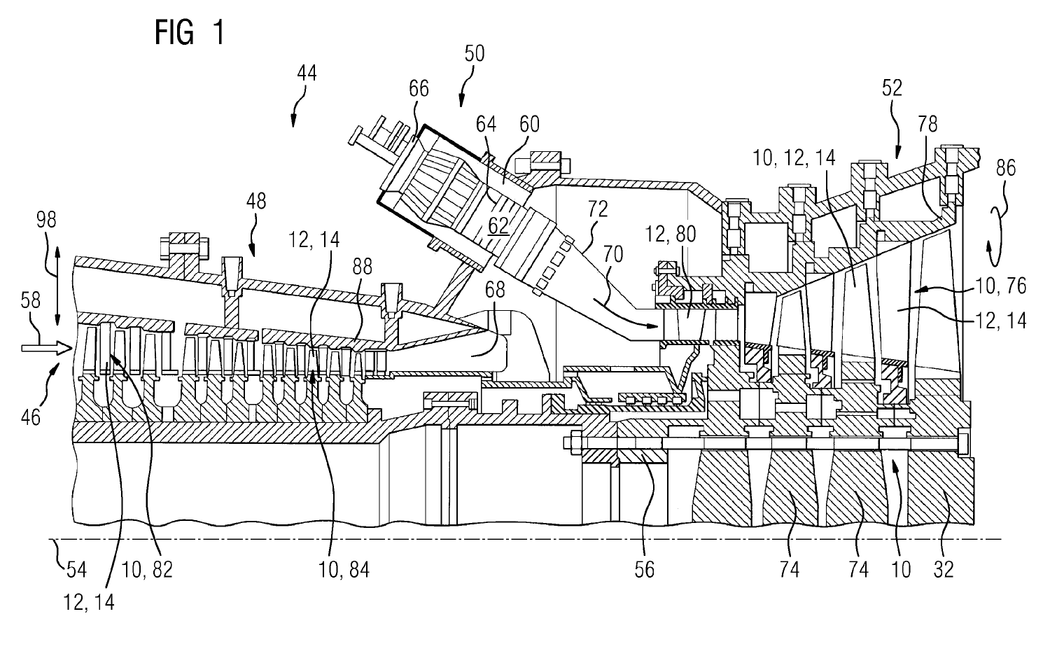

FIG. 1 shows an example of a gas turbine engine 44 in a sectional view. The gas turbine engine 44 comprises, in flow series, an inlet 46, a compressor section 48, a combustion section 50 and a turbine section 52, which are generally arranged in flow series and generally in the direction of a longitudinal or rotational axis 54. The gas turbine engine 44 further comprises a shaft 56 which is rotatable about the rotational axis 54 and which extends longitudinally through the gas turbine engine 44. The shaft 56 drivingly connects the turbine section 52 to the compressor section 48.

In operation of the gas turbine engine 44, air 58, which is taken in through the air inlet 46 is compressed by the compressor section 48 and delivered to the combustion section or burner section 50. The burner section 50 comprises a burner plenum 60, one or more combustion chambers 62 defined by a double wall can 64 (not shown in detail) and at least one burner 66 fixed to each combustion chamber 62. The combustion chamber(s) 62 and the burner(s) 66 are located inside the burner plenum 60. The compressed air passing through the compressor section 48 enters a diffuser 68 and is discharged from the diffuser 68 into the burner plenum 60 from where a portion of the air enters the burner 66 and is mixed with a gaseous or liquid fuel. The air/fuel mixture is then burned and the combustion gas 70 or working gas from the combustion is channelled via a transition duct 72 to the turbine section 52.

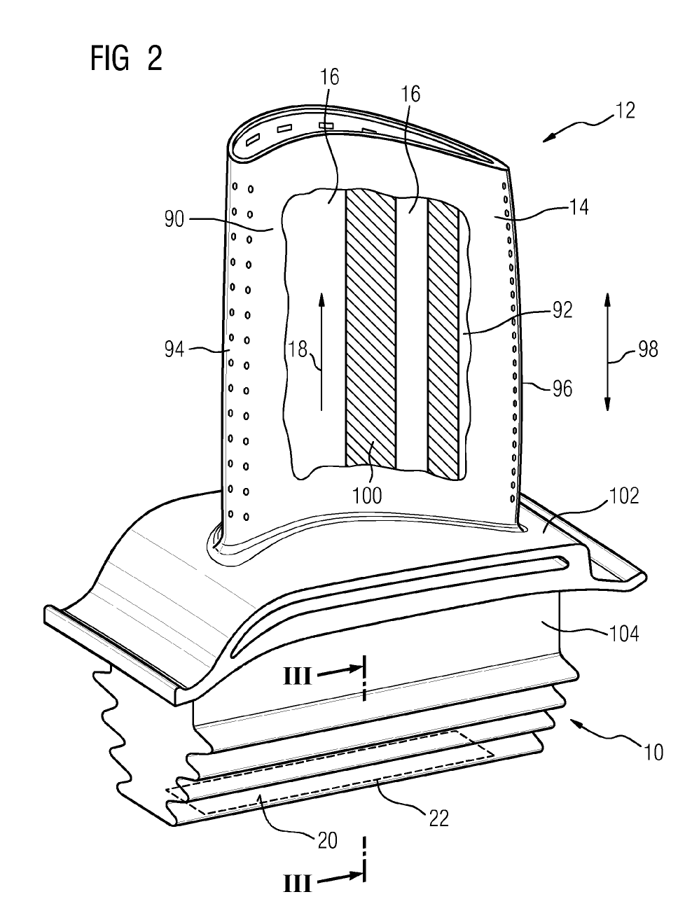

The turbine section 52 comprises a number of blade carrying production discs 74 or turbine wheels attached to the shaft 56. In the present example, the turbine section 52 comprises four discs 74 each carry an annular array of turbine assemblies 10 which each comprises an aerofoil unit 12 (see FIG. 2) with an aerofoil 14 embodied as a turbine blade. However, the number of blade carrying production discs 74 could be different, i.e. only one production disc 74 or more than four production discs 74. In addition, turbine assemblies 10 embodied as turbine cascades 76 with aerofoil units 12 are disposed between the turbine blades 42. Each turbine cascade 76 carries an annular array of aerofoil units 12 which each comprises an aerofoil 14 in the form of guiding vanes, which are fixed to a stator 78 of the gas turbine engine 44. Between the exit of the combustion chamber 62 and the leading turbine blades inlet guiding vanes or nozzle guide vanes 80 are provided.

The combustion gas 70 from the combustion chamber 62 enters the turbine section 52 and drives the turbine blades which in turn rotate the shaft 56. The guiding vanes 80 serve to optimise the angle of the combustion or working gas 70 on to the turbine blades. The compressor section 48 comprises an axial series of guide vane stages 82 and rotor blade stages 84 with turbine assemblies 10 comprising aerofoil units 12 or turbine blades or vanes, respectively. In circumferential direction 86 around the turbine assemblies 10 the turbine engine 44 comprises a stationary casing 88.

FIG. 2 shows in a perspective view a turbine assembly 10 of the gas turbine engine 44 with an aerofoil unit 12 and a cover plate 22. The aerofoil unit 12 comprises a basically hollow aerofoil 14 embodied as a turbine blade, with two cooling regions, specifically, a channelled cooling region 90 and a fin-pin/pedestal cooling region 92. The former is located at a leading edge 94 and the latter at a trailing edge 96 of the aerofoil 14. The aerofoil 14 or its channelled cooling region 90, respectively, comprises two cooling passages 16 for a cooling medium 18. The cooling passages 16 extend in span wise direction 98 of the aerofoil 14 and are separated by rips 100. Moreover, the cooling passages 16 may be in flow communication with each other or with other cooling features of the aerofoil 14, like film cooling holes, impingement devices or the like (not specified or shown).

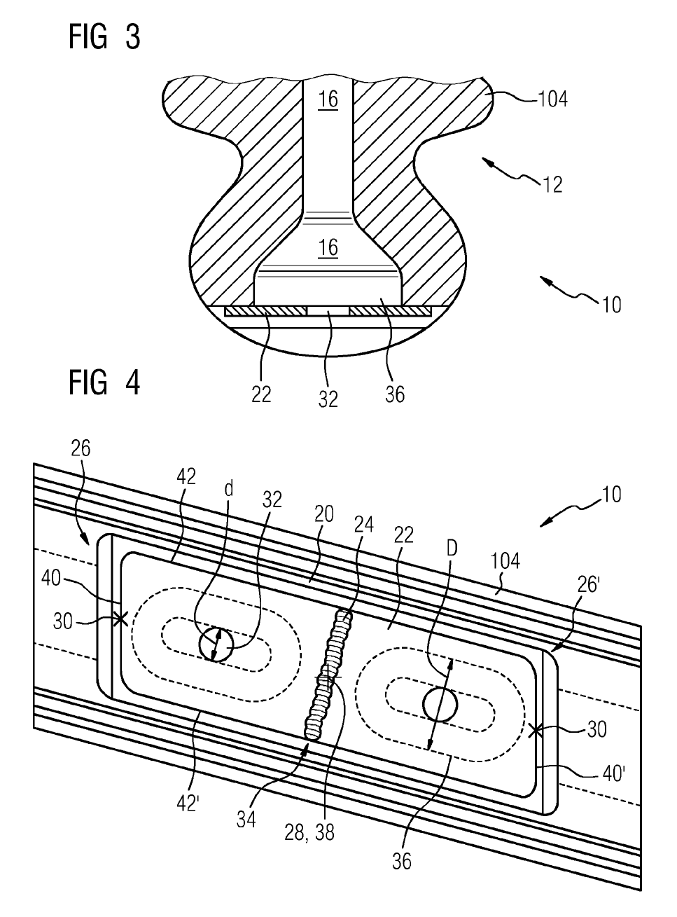

The aerofoil unit 12 further comprises a platform 102 and a root portion 104, wherein the platform 102 is arranged in span wise direction 98 between the aerofoil 14 and the root portion 104. Further, the aerofoil unit 12 may comprise an outer platform, embodied as a shroud, at its tip, which is not shown in FIG. 2. Moreover, the aerofoil is basically sealed at its tip. The aerofoil unit 12 or its root portion 104 comprises an entry surface 20, wherein the cooling medium 18 enter at the entry surface 20 through apertures 36 communicating with the cooling passages 16 (see FIG. 3 that shows a cross section along line III-III in FIG. 2). The cover plate 22 is attached to the aerofoil unit 12 or its root portion 104 at the entry surface 20 to partially cover the entry surface 20 or the apertures 36.

This could be seen in FIG. 4 that shows a bottom view of the turbine assembly 10 with the attached cover plate 22, wherein the covered apertures 36 of the root portion 104 are shown in dashed lines. The cover plate 22 has a basically tetragonal and rectangular shape and in this exemplary embodiment two orifices 32 communicating with the two apertures 36 of the aerofoil unit 12 or the cooling passages 16. Each orifice 32 of the cover plate 22 has a smaller diameter d than a diameter D of the two apertures 36 of the aerofoil unit 12.

The cover plate 22 is attaching to the aerofoil unit 12 or its root portion 104, respectively, with one single, continuous, connecting structure 24. This is done by welding the cover plate 22 to the aerofoil unit 12, thus forming one single, continuous, one-directional weld.

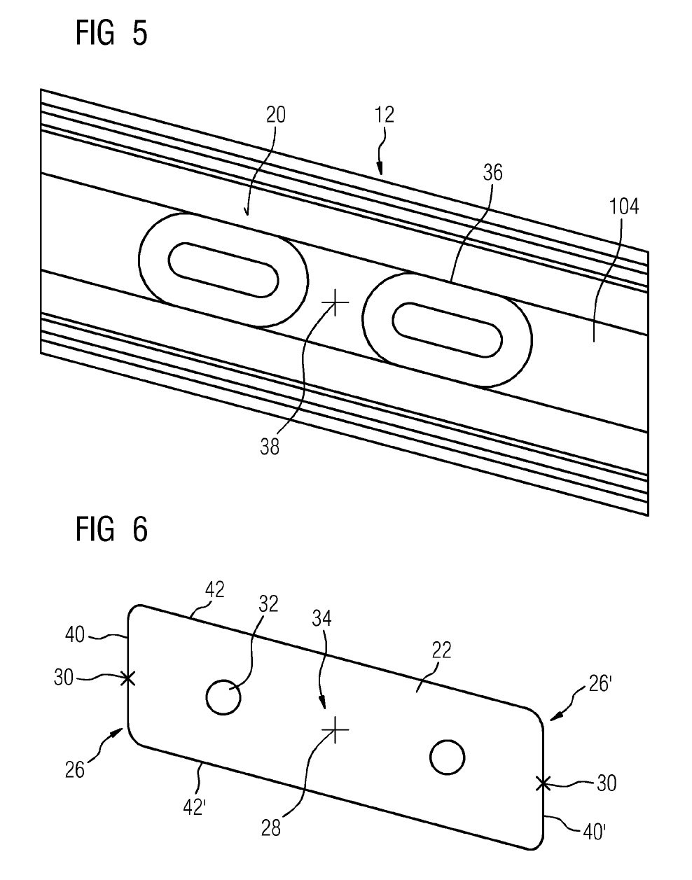

The connecting structure 24 or the weld, respectively, is positioned basically in a middle 34 between the two orifices 32 of cover plate 22 (see also FIG. 6 that shows the cover plate unattached to the aerofoil unit 12) and extends through a mid-point 38 being located basically in a middle between the two apertures 36 of the root portion 104 (see also FIG. 5 that shows a bottom view of the turbine assembly 10 with the entry surface 20). Thus, the orifices 32 of the cover plate 22 and the apertures 36 of the root portion 104 are arranged aligned to each other and with mirror symmetry to each other, wherein the connecting structure 24 is the symmetry axis.

Due to the rectangular shape of the cover plate 22 it comprises four borders 40, 40′, 42, 42′, wherein two sets of opposed borders 40, 40′, 42, 42′ or a first set of two opposed borders 40, 40′ and a second set of two opposed borders 42, 42′ are formed. The first set of two opposed borders 40, 40′ are shorter than the second set of two opposed borders 42, 42′. The connecting structure 24 extends all between two opposed borders 42, 42′ and specifically between the second set of longer borders 42, 42′ and basically perpendicular the second set of two opposed borders 42, 42′. In other words the connecting structure 24 may extend from one border 42 (40) to the other opposing border 42′ (42); alternatively, the connecting structure 24 may extend only part of the distance between the opposed borders 42, 42′ or 40, 42′ and not necessarily from one or to the other opposed border. The connecting structure 24 may be arranged to run along the longest dimension of the cover plate 22 or along the shortest dimension of the cover plate 22 as shown in FIG. 4 for example. The connecting structure 24 may be generally perpendicular to the borders 42, 42′ as shown in FIG. 4, but the connecting structure may be angled from perpendicular to one or both borders.

Moreover, the cover plate 22 has a centroid 28 and the connecting structure 24 extends through the centroid 28 (see also FIG. 5). Further, the cover plate 22 has several edge points 30 at one end 26, 26′ or as a part of one border 40, 40′ of the cover plate 22 (for better presentability only one edge point 30 is marked for each end 26, 26′/border 40, 40′). A metric function of the centroid 28 and each edge point 30 has a maximum and the maximum is or all maxima are located at the end 26, 26′ or the border 40, 40′.

By attaching the cover plate 22 via the connecting structure 24 that extends through the centroid 28 the ends 26, 26′ or the borders 42, 42′ with the edge points 30 are free or unattached to the aerofoil unit 12 or the root portion 104. Thus, in the attached state the cover plate 22 has free ends 26, 26′. During operation of the engine 44 and the turbine assembly 10 centrifugal forces are acting on the cover plate 22. Due to the free ends 26, 26′ the cover plate 22 is or the ends 26, 26′ are able to be pressed tight to the entry surface 20. Hence, the cover plate 22 seals the cooling passages 16 to prevent an unintended flow of cooling medium 18 into and/or from the cooling passage 16 during operation of the turbine assembly 10. Consequently, the cover plate 22 is used as a sealing plate.

It should be noted that the term “comprising” does not exclude other elements or steps and “a” or “an” does not exclude a plurality. Also elements described in association with different embodiments may be combined. It should also be noted that reference signs in the claims should not be construed as limiting the scope of the claims.

Although the invention is illustrated and described in detail by the preferred embodiments, the invention is not limited by the examples disclosed, and other variations can be derived therefrom by a person skilled in the art without departing from the scope of the invention.

1. A method for manufacturing a turbine assembly comprising at least one aerofoil unit comprising at least a basically hollow aerofoil with at least one cooling passage for a cooling medium and at least one entry surface, wherein the at least one cooling passage enters at the at least one entry surface, and further the turbine assembly comprises at least one cover plate that at least partially covers the at least one entry surface, wherein the method comprises:
attaching the at least one cover plate with one single, continuous, connecting structure to the at least one aerofoil unit.

2. The method according to claim 1,
wherein the at least one cover plate comprises at least one end, a centroid and an edge point, wherein a metric function of the centroid and the edge point has a maximum and wherein the maximum is located at the at least one end of the at least one cover plate and wherein the method comprises:
attaching the at least one cover plate in such a way so that the at least one end is a free end in respect to the at least one aerofoil unit.

3. The method according to claim 1,
wherein the at least one cover plate comprises a centroid and wherein the method comprises:
attaching the at least one cover plate in such a way that the connecting structure extends through the centroid.

4. The method according to claim 1,
wherein the method comprises:
attaching the at least one cover plate by welding.

5. The method according to claim 1,
wherein the at least one cover plate comprises at least two orifices that are in communication with the cooling passage wherein the method comprises:
attaching the at least one cover plate to the at least one aerofoil unit basically in a middle between the at least two orifices of the at least one cover plate.

6. A turbine assembly comprising
at least one aerofoil unit comprising at least one basically hollow aerofoil with at least one cooling passage for a cooling medium and at least one entry surface, wherein the at least one cooling passage enters at the at least one entry surface, and
further comprising at least one cover plate that at least partially covers the at least one entry surface,
wherein the turbine assembly is manufactured according to the method of claim 1.

7. The turbine assembly according to claim 6,
wherein the at least one aerofoil unit comprises at least two apertures communicating with the at least one cooling passage and
wherein the connecting structure extends through a mid-point being located basically in a middle between the at least two apertures.

8. The turbine assembly according to claim 6,
wherein the at least one cover plate comprises at least one border, a centroid and an edge point, wherein a metric function of the centroid and the edge point has a maximum and wherein a maximum of the metric function is located on the at least one border of the at least one cover plate and wherein the at least one border is unattached to the at least one aerofoil unit.

9. The turbine assembly according to claim 6,
wherein the at least one cover plate comprises two opposed borders, wherein the connecting structure extends between the two opposed borders.

10. The turbine assembly according to claim 6,
wherein the at least one cover plate comprises two opposed borders, wherein the connecting structure extends all between the two opposed borders.

11. The turbine assembly according to claim 6,
wherein the at least one cover plate comprises a first set of two opposed borders and a second set of two opposed borders, wherein the first set of two opposed borders are shorter than the second set of two opposed borders and/or wherein the connecting structure extends basically perpendicular to the opposed borders of the second set of two opposed borders.

12. The turbine assembly according to claim 6,
wherein the at least one cover plate has a basically tetragonal shape and preferably, or a basically rectangular shape.

13. The turbine assembly according to claim 6,
wherein the at least one aerofoil unit comprises at least two apertures communicating with the at least one cooling passage and wherein the at least one cover plate comprises at least one orifice communicating with at least one aperture of the at least two apertures of the aerofoil unit.

14. The turbine assembly according to claim 6,
wherein the at least one aerofoil unit comprises at least two apertures communicating with the at least one cooling passage and wherein the at least one cover plate comprises at least one orifice that has a smaller diameter (d) than a diameter (D) of at least one aperture of the at least two apertures of the aerofoil unit.

15. A method of sealing using Use of a cover plate as a sealing plate, the method comprising:
sealing with the cover plate at least one cooling passage of an aerofoil unit of a turbine assembly according to claim 6 to prevent a flow of cooling medium into and/or from the at least one cooling passage during operation of the turbine assembly.
